(19) United States
(12) Patent Application Publication
(10) Pub. No.: US 2025/0023783 A1
(43) Pub. Date: Jan. 16, 2025

(54) PROGRAM GENERATION SYSTEM, PROGRAM GENERATION METHOD, SERVICE SYSTEM, AND SERVICE SYSTEM EXECUTION METHOD

(71) Applicant: XINCHEN FINTECH CO., LTD., Taipei City (TW)

(72) Inventor: Hsin-Ho Yeh, Taipei City (TW)

(73) Assignee: XINCHEN FINTECH CO., LTD., Taipei City (TW)

(21) Appl. No.: 18/770,457

(22) Filed: Jul. 11, 2024

(30) Foreign Application Priority Data
Jul. 12, 2023 (TW) 112126083

(51) Int. Cl. H04L 41/08; H04L 41/085

(52) U.S. Cl. CPC H04L 41/0886; H04L 41/085

(57) ABSTRACT

A service system execution method is applicable to a service system and includes: calling a plurality of methods sequentially by a control unit based on an external request; generating and running an instance by a service unit based on a first indication and closing the aforementioned instance based on a second indication; receiving call parameters of a current method by a routing unit and executing: recording a request and the call parameters of the current method in response to a number of instances corresponding to the current method being zero; and selecting a service instance from the running instances corresponding to the current method based on a selection procedure in response to the number of instances corresponding to the current method being non-zero; and controlling a survival status of all the instances and executing an extension procedure at predetermined intervals by an extension control unit.

### CROSS-REFERENCE TO RELATED APPLICATION

This non-provisional application claims priority under 35 U.S.C. § 119 (a) to patent application No. 112126083 filed in Taiwan, R.O.C. on Jul. 12, 2023, the entire contents of which are hereby incorporated by reference.

### BACKGROUND

### Technical Field

The present invention relates to a micro application procedure management technology, in particular to a micro application procedure management and assignment technology for reducing required computing resources.

### Related Art

Traditionally, in a monolithic application procedure, more monolithic application procedures will be added through horizontal extension to meet the service request. However, this may consume excessive computing resources.

### SUMMARY

In view of this, some embodiments of the present invention provide a program generation system, a program generation method, a service system and a service system execution method to address technical issues which are currently encountered.

Some embodiments of the present invention provide a program generation system, including at least one processing unit. The at least one processing unit is configured to receive a main program including a main method and at least one submethod of a request category, and execute the following steps: parsing and reading the at least one submethod of the request category in the main program, and embedding each of the parsed and read at least one submethod into a corresponding first communication interface function code to generate at least one generated submethod; and parsing and reading the main method in the main program, and embedding the parsed and read main method and each of the parsed and read at least one submethod into a corresponding second communication interface function code to generate a generated main method.

Some embodiments of the present invention provide a service system cooperating with the program generation system, including a control unit, a service unit, a routing unit and an extension control unit. The control unit is configured to receive an external request and call a plurality of methods sequentially based on the external request; the service unit is configured to generate and run an instance based on a first indication and close the instance based on a second indication, the instance corresponding to one of the methods; the routing unit is configured to receive a call parameter of a current method called from the methods and execute: recording a request of the current method and the call parameter of the current method in response to a number of instances corresponding to the current method being zero; and selecting a service instance from at least one running instance corresponding to the current method based on a selection procedure in response to the number of instances corresponding to the current method being non-zero; and the extension control unit is configured to control a survival status of all the instances generated by the service unit and execute an extension procedure to adjust the number of instances corresponding to each of the methods of the service unit at predetermined intervals, where the control unit executes the generated main method, and the methods are the at least one generated submethod.

Some embodiments of the present invention provide a service system, including a control unit, a service unit, a routing unit and an extension control unit. The control unit is configured to receive an external request and call a plurality of methods sequentially based on the external request; the service unit is configured to generate and run an instance based on a first indication and close the instance based on a second indication, the instance corresponding to one of the methods; the routing unit is configured to receive a call parameter of a current method called from the methods and execute: recording a request of the current method and the call parameter of the current method in response to a number of instances corresponding to the current method being zero; and selecting a service instance from at least one running instance corresponding to the current method based on a selection procedure in response to the number of instances corresponding to the current method being non-zero; and the extension control unit is configured to control a survival status of all the instances generated by the service unit and execute an extension procedure to adjust the number of instances corresponding to each of the methods of the service unit at predetermined intervals.

Some embodiments of the present invention provide a program generation method, executed by at least one processing unit, including the following steps: receiving a main program including a main method and at least one submethod of a request category; parsing and reading the at least one submethod of the request category in the main program, and embedding each of the parsed and read at least one submethod into a corresponding first communication interface function code to generate at least one generated submethod; and parsing and reading the main method in the main program, and embedding the parsed and read main method and each of the parsed and read at least one submethod into a corresponding second communication interface function code to generate a generated main method.

Some embodiments of the present invention provide a service system execution method cooperating with the program generation method, applicable to a service system including a control unit, a service unit, a routing unit and an extension control unit. The service system execution method includes the following steps: receiving an external request and calling a plurality of methods sequentially based on the external request by the control unit; generating and running an instance based on a first indication and closing the instance based on a second indication by the service unit, the instance corresponding to one of the methods; receiving a call parameter of a current method called from the methods and executing: recording a request of the current method and the call parameter of the current method in response to a number of instances corresponding to the current method being zero; and selecting a service instance from at least one running instance corresponding to the current method based on a selection procedure in response to the number of instances corresponding to the current method being non-zero; and controlling a survival status of all the instances generated by the service unit by the extension control unit and executing an extension procedure to adjust the number of instances corresponding to each of the methods of the service unit at predetermined intervals by the routing unit, where the control unit executes the generated main method, and the methods are the at least one generated submethod.

Some embodiments of the present invention provide a service system execution method, applicable to a service system including a control unit, a service unit, a routing unit and an extension control unit. The service system execution method includes the following steps: receiving an external request and calling a plurality of methods sequentially based on the external request by the control unit; generating and running an instance based on a first indication and closing the instance based on a second indication by the service unit, the instance corresponding to one of the methods; receiving a call parameter of a current method called from the methods and executing: recording a request of the current method and the call parameter of the current method in response to a number of instances corresponding to the current method being zero; and selecting a service instance from at least one running instance corresponding to the current method based on a selection procedure in response to the number of instances corresponding to the current method being non-zero by the routing unit; and controlling a survival status of all the instances generated by the service unit and executing an extension procedure to adjust the number of instances corresponding to each method of the service unit at predetermined intervals by the extension control unit.

Based on the above, the program generation system, the program generation method, the service system and the service system execution method provided by some embodiments of the present invention can reduce the consumption of computing resources under the cooperation of the control unit, the service unit, the routing unit and the extension control unit.

### BRIEF DESCRIPTION OF THE DRAWINGS

FIG. 1 is a block diagram of a service system according to an embodiment of the present invention;

FIG. 2-1 is a schematic diagram showing an instance and a routing unit according to some embodiments of the present invention;

FIG. 2-2 is a schematic diagram showing the operation of a control unit and a routing unit according to some embodiments of the present invention;

FIG. 3 is a block diagram of an extension control unit according to an embodiment of the present invention;

FIG. 4 is a schematic diagram showing the operation of the extension control unit according to some embodiments of the present invention;

FIG. 5 is a schematic diagram showing the operation of the extension control unit according to some embodiments of the present invention;

FIG. 6 is a schematic diagram showing the operation of the extension control unit according to some embodiments of the present invention;

FIG. 7 is a schematic diagram showing the implementation of a service system according to some embodiments of the present invention;

FIG. 8 is a schematic diagram showing the implementation of a service system according to some embodiments of the present invention;

FIG. 9 is a schematic diagram showing the implementation of a service system according to some embodiments of the present invention;

FIG. 10 is a block diagram of a program generation system according to an embodiment of the present invention;

FIG. 11 is a schematic flowchart showing program generation according to an embodiment of the present invention;

FIG. 12 is a flowchart of a service system execution method according to some embodiments of the present invention;

FIG. 13 is a flowchart of a selection procedure according to some embodiments of the present invention;

FIG. 14 is a flowchart of an extension procedure according to some embodiments of the present invention;

FIG. 15 is a flowchart of an extension procedure according to some embodiments of the present invention;

FIG. 16 is a flowchart of an extension procedure according to some embodiments of the present invention;

FIG. 17 is a flowchart of a service system execution method according to some embodiments of the present invention; and

FIG. 18 is a flowchart of a program generation method according to an embodiment of the present invention.

### DETAILED DESCRIPTION

The foregoing and other technical contents, features and efficacies of the present invention will be clearly presented in the following detailed description of embodiments with reference to the drawings. Any modification and change that does not affect the efficacies and objectives of the present invention shall still fall within the scope of the technical contents disclosed in the present invention. The same reference numerals in all drawings will be used to indicate the same or similar elements. The term “connection” mentioned in the following embodiments may refer to any direct or indirect, wired or wireless connection means.

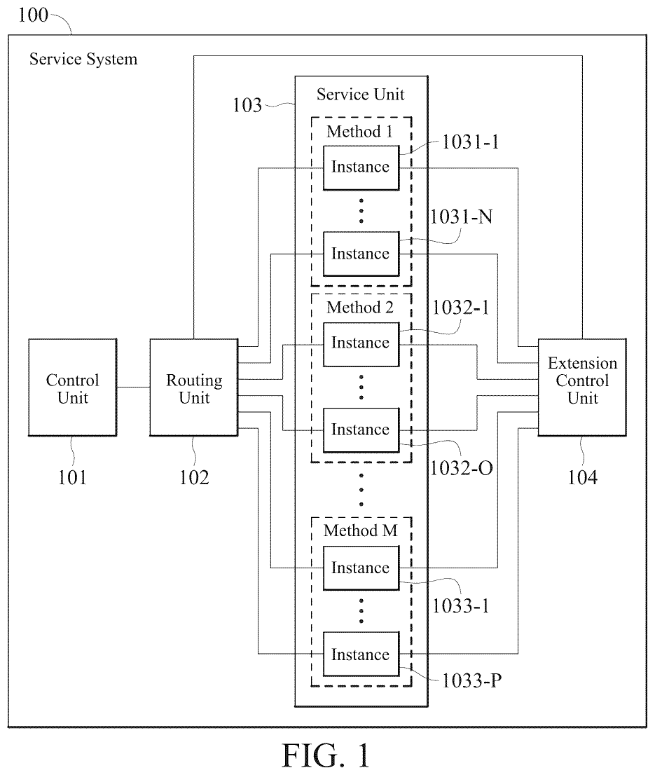

FIG. 1 is a block diagram of a service system according to an embodiment of the present invention. Referring to FIG. 1, the service system 100 includes a control unit 101, a service unit 103, a routing unit 102 and an extension control unit 104. The control unit 101 is configured to receive an external request and call a plurality of methods (method 1, method 2 to method M, where M is a positive integer) sequentially based on the external request. It should be noted that the control unit 101 may simultaneously receive external requests generated by different users, and call method 1, method 2 to method M corresponding to the external requests generated by different users in parallel. The service unit 103 is configured to generate and run an instance based on a first indication and close the instance based on the second indication. The instance corresponds to one of method 1, method 2 to method M such that the instance can execute the corresponding method. In the example shown in FIG. 1, the service unit 103 generates and runs instances 1031-1 to 1031-N, instances 1032-1 to 1032-O and instances 1033-1 to 1033-P. N, O and P are integers. The instances 1031-1 to 1031-N correspond to method 1, the instances 1032-1 to 1032-O correspond to method 2, and the instances 1033-1 to 1033-P correspond to method M. Therefore, each of the instances 1031-1 to 1031-N may execute method 1, each of the instances 1032-1 to 1032-O may execute method 2, and each of the instances 1033-1 to 1033-P may execute method 3. The service unit 103 may close the instances 1031-1 to 1031-N, instances 1032-1 to 1032-O and instances 1033-1 to 1033-P based on the second indication. The instances corresponding to each method may be closed to zero. That is, there may be methods for which there are no corresponding instances currently executed on the service unit 103.

In some embodiments of the present invention, each instance is configured with a set of unique Internet Protocol Address (IP Address) and port. For example, the instance 1031-1 is configured with an IP address 10.1.10.101 and a port 9999, which are expressed as 10.1.10.101:9999 as a whole. Moreover, each instance has two paths: a metric path and a method path. Accessing the metric path of the instance may obtain resource information of the instance. In some embodiments of the present invention, the resource information includes: which physical machine the instance is running on, the IP address and port allocated to the instance, the category of function to be executed by the instance, the current Central Processing Unit (CPU) load level of the instance, and the current health level of the instance. Accessing the method path of the instance may obtain a computing result of the method corresponding to the instance. The metric path is represented by/metric, and the method path is represented by/method. Taking the instance 1031-1 as an example, accessing “http://10.1.10.101:9999/metric” may obtain resource information of the instance 1031-1, and accessing “http://10.1.10.101:9999/method” may obtain a computing result of method 1 corresponding to the instance 1031-1.

In this embodiment, the resource information of the instance is stored in a storage format of “key: value”. The “key” of which physical machine the instance is running on is “hostname”, the “key” of the IP address and port allocated to the instance is “ipport”, the “key” of the category of function to be executed by the instance is “category”, the “key” of the current CPU load level of the instance is “cpu_load”, and the “key” of the current health level of the instance is “instance_status”.

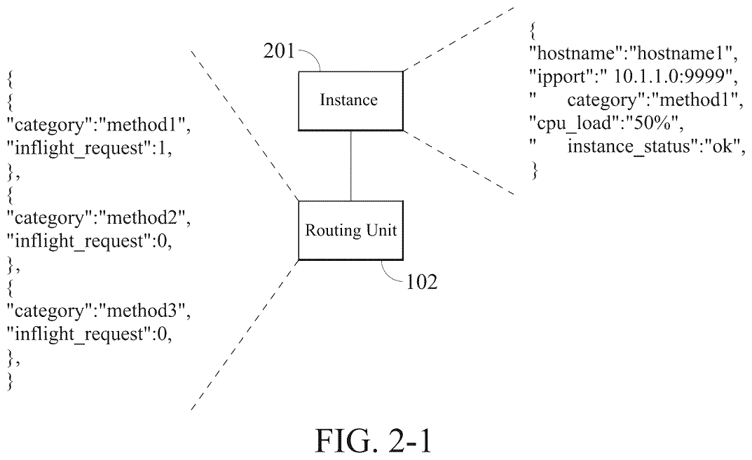

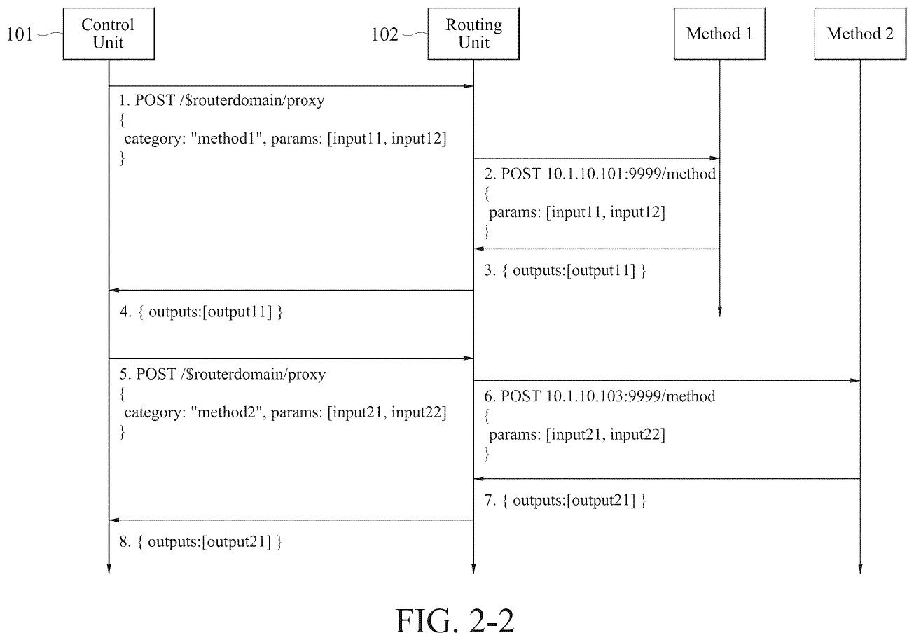

FIG. 2-1 is a schematic diagram showing an instance and a routing unit according to some embodiments of the present invention. Referring to FIG. 2-1, after accessing the instance 201, the resource information of the instance 201 is obtained:

```
{
  “hostname “: “hostname1 “,
  “ipport “: “10.1.10.101:9999 “,
  “category “: “method1 “,
  “cpu_load “: “50% “,
  “instance_status “: “ok “,
}
```

It indicates that the instance is running on a physical machine named hostname1, the IP address and port allocated to the instance is 10.1.10.101:9999, the category of function to be executed by the instance is method1, where method1 is the name of method 1, the current CPU load level of the instance is 50%, and the current health level of the instance is ok.

When method 1, method 2 to method M are sequentially called in the control unit 101, the control unit 101 sends, for the current method (for example, method 1) that is currently called, a request category (for example, method 1, method 2 or another method) and a request parameter (for example, an input parameter of the current method) of the current method to the routing unit 102 as call parameters, so as to request the routing unit 102 to forward the call parameters to the instance corresponding to the request category of the current method in the service unit 103. After receiving the request, the routing unit 102 forwards the call parameters to the instance corresponding to the request category of the current method in the service unit 103. In this embodiment, method 1 is represented by the string “method1”, method 2 is represented by the string “method2”, and so on. The request category and the request parameter are stored and transmitted in the form of “key: value”. The key “category” represents the request category, and its corresponding value may be the string “method1”, the string “method2” or another string representing the method. The key “args” represents the request parameter. For example, {“category”: “method1”, “params”: [method1-arg1, method1-arg2]} indicates that the request category sent to the routing unit 102 is method 1, and the input parameters of method 1 are method1-arg1 and method1-arg2.

The routing unit 102 may obtain the IP address and port of the running instance corresponding to the current method (for example, method 1) from the extension control unit 104. Since the service unit 103 may currently have no running instances corresponding to the current method (for example, method 1), that is, the number of instances corresponding to the current method is zero, at this time, the routing unit 102 may record the request of the current method and the call parameters of the current method. As described above, the control unit 101 may simultaneously receive external requests generated by different users, and call method 1, method 2 to method M in parallel corresponding to the external requests generated by different users. Therefore, at the same time, there may be a plurality of method 1 requests corresponding to different users that do not have corresponding running instances. In some embodiments of the present invention, the routing unit 102 may record and store, in the form of “key: value”, which methods of request categories currently have no running instances, and the number of methods that have no running instances so as to record the request of the current method. The key “category” represents the request category, and the key “inflight_request” represents the number of requests of this request category that currently have no corresponding running instances. For example, in the following Table (I):

TABLE (I)

```
  {
  “category”: “method1”,
  “inflight_request”:1,
  },
  {
  “category”: “method2”,
  “inflight_request”:0,
  },
  {
  “category”: “method3”,
  inflight_request”:0,
  },
}
```

It means that method 1 has 1 request that currently has no corresponding running instances, and method 2 and method 3 have 0 requests that currently have no corresponding running instances. It should be noted that “method 2 and method 3 have 0 requests that currently have no corresponding running instances” does not indicate that the service unit 103 currently has instances corresponding to method 2 or method 3, but may indicate that the control unit 101 currently has not sent the request of method 2 or method 3 or that the routing unit 102 has found corresponding instances for requests of both method 2 and method 3 sent by the control unit 101.

The routing unit 102 has two paths: a metric path and a forwarding path. The control unit 101 sends the call parameters of the current method (the request category and the request parameter (for example, the input parameter of the current method)) to the routing unit 102 via the forwarding path of the routing unit 102. Moreover, as shown in FIG. 2-1, accessing the metric path of the routing unit 102 may obtain Table (I) to obtain which methods have requests but no corresponding instances.

The routing unit 102 has a storage space for storing Table (I). After the routing unit 102 receives the request of the current method sent by the control unit 101, the routing unit 102 obtains the IP address and port of the running instance corresponding to the current method (for example, method 1) from the extension control unit 104. If the number of instances corresponding to the current method is zero, the routing unit 102 records the call parameters of the current method, and the routing unit 102 updates Table (I) to record the request of the current method. If the number of instances corresponding to the current method is non-zero, the routing unit 102 selects a service instance from the running instances corresponding to the current method based on a selection procedure to execute the current method.

In some embodiments of the present invention, the routing unit 102 is implemented as an HTTP Reverse Proxy Server. For example, the routing unit may be implemented using the following Python code ((http-reverse-proxy.py):

```
  import json
  import requests
  from http.server import BaseHTTPRequestHandler,HTTPServer
  from typing import Dict
  method_and_instance_ips = {
      ‘method1’ : [ ‘10.1.10.101:9999’ , ‘10.1.10.102:9999’ , ‘10.1.10.105:9999’ ],
      ‘method2’ : [ ‘10.1.10.103:9999’ , ‘10.1.10.104:9999’ ],
      ‘method3’ : [ ],
  }
  def get_method_from_body(json_body: Dict):
    return json_body[ ‘category’ ]
  def pick_one(instance_ips: [ str ]) −> str :
    # in this example, we only pick the first one
    return instance_ips[ 0 ]
  def get_method_ips_or_wait(method: str ) −> str :
    if method in method_and_instance_ips and len
(method_and_instance_ips[method]) > 0 :
      return pick_one(method_and_instance_ips[method])
    else :
      import time
      time.sleep( 1 )
      return get_method_ips_or_wait(method)
  class ProxyHTTPRequestHandler(BaseHTTPRequestHandler):
    def _{——}init_{——}(self, port= 9999 ):
      self.port = port
    def do_POST(self, body=True):
    if self.path == ‘/proxy’ :
        return self.do_proxy(self, body)
    def do_proxy(self, body=True):
      content_len = int (self.headers.getheader( ‘content-length’ , 0 ))
      post_body = self.rfile.read(content_len)
      post_body_json = json.load(post_body)
      destination_ip =
get_method_ips_or_wait(get_method_from_body(post_body_json))
      url = ‘http://{ }/method’. format (destination_ip)
      req_body = { ‘parmas' : post_body_json[ ‘params’ ]}
      req_header = self.parse_headers( )
      resp = requests.post(url, data=req_body, headers=req_header)
      # forward response body and header to the actual client
      self.send_response(resp.status_code)
      self.send_resp_headers(resp)
      if body:
        self.wfile.write(resp.content)
      return
    def parse_headers(self):
      req_header = { }
      for line in self.headers:
        line_parts = [o.strip( ) for o in line.split( ‘:’, 1 )]
        if len (line_parts) == 2 :
          req_header[line_parts[ 0 ]] = line_parts[ 1 ]
      return req_header
    def send_resp_headers(self, resp):
      respheaders = resp.headers
      for key in respheaders:
        self.send_header(key, respheaders[key])
      self.send_header( ‘Content-Length’, len (resp.content))
      self.end_headers( )
    def serve(self):
      httpd = HTTPSever(( ‘0.0.0.0’ , self.port), self)
      httpd.serve_forever( )
  ProxyHTTPRequestHandler( ).serve( )
```

FIG. 2-2 is a schematic diagram showing the operation of a control unit and a routing unit according to some embodiments of the present invention. Referring to FIG. 2-2, in the method shown in FIG. 2-2, the value of M is 2. The control unit 101 receives an external request, and calls method 1 and method 2 sequentially based on the external request. As shown in FIG. 2-2, when the control unit 101 calls method 1, the current method is method 1, and the control unit 101 sends the request category (which is currently method 1) and the request parameter (request category and request parameter are stored and transmitted in the form of “key: value” in this embodiment, where the key category represents the category of the request method whose corresponding value is a string, and the content of the string is a request name of the current method, such as method1 shown in FIG. 2-2; and the key params represents the request parameter whose corresponding value is a list, and the content of the list is the request parameter of the current method, such as [input11, input12] shown in FIG. 2-2) of the current method to the routing unit 102 as the call parameters, so as to request the routing unit 102 to forward the call parameters to the instance corresponding to the request category of the current method in the service unit 103 in accordance with the value of the key category being method1. After the instance corresponding to the request category of the current method is executed, a computing result is returned to the control unit 101 through the routing unit 102. In this embodiment, the computing result is stored and transmitted in the form of “key: value”, where the key outputs represent the computing result whose corresponding value is a list, and the content of the list is the computing result, such as outputs: [output11] shown in FIG. 2-2. It should be noted that if the current method has no computing result to be returned, its corresponding value may be an empty list.

After the control unit 101 receives the return of the instance corresponding to the request category of method 1, when the control unit 101 calls method 2 in sequence, the process is the same as method 1. The control unit 101 sends the request category (which is currently method 2, such as category: method2 shown in FIG. 2-2) and the request parameter (params: [input21, input22] shown in FIG. 2-2) of method 2 to the routing unit 102 as the call parameters, so as to request the routing unit 102 to forward the call parameters to the instance corresponding to the request category of the current method in the service unit 103. After the instance corresponding to the request category of the current method is executed, a computing result (outputs: [output21]) is returned to the control unit 101 through the routing unit 102.

The extension control unit 104 is configured to control a survival status of all the instances generated by the service unit 103 and execute an extension procedure to adjust the number of instances corresponding to each of method 1, method 2 to method M in the service unit 103 at predetermined intervals.

The service system execution method according to some embodiments of the present invention and how modules of the service system 100 cooperate with each other will be described in detail below with reference to the accompanying drawings.

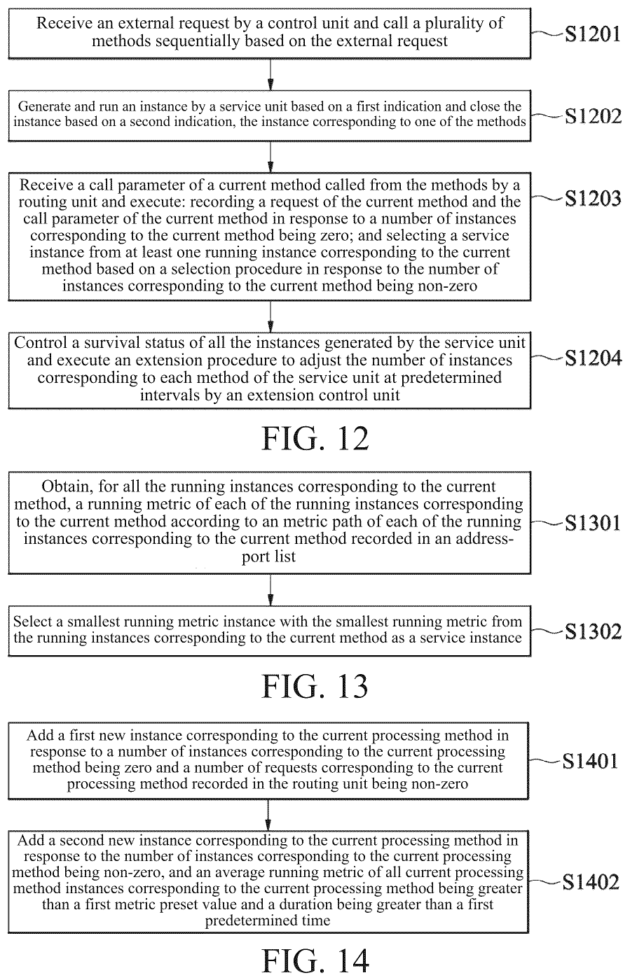

FIG. 12 is a flowchart of a service system execution method according to some embodiments of the present invention. Referring to FIG. 1, FIG. 2-1 to FIG. 2-2 and FIG. 12, in the embodiment shown in FIG. 12, the service system execution method includes step S1201 to step S1204. In step S1201, the control unit 101 receives an external request, and calls a plurality of methods (for example, method 1, method 2 to method M) sequentially based on the external request. In step S1202, the service unit 103 generates and runs an instance based on a first indication and closes the instance based on a second indication. The instance corresponds to one of the plurality of methods. In step S1203, the routing unit 102 receives a call parameter of the current method called from the aforementioned methods, and the routing unit 102 executes: recording a request of the current method and the call parameter of the current method in response to a number of instances corresponding to the current method being zero; and selecting a service instance from at least one running instance corresponding to the current method based on a selection procedure in response to the number of instances corresponding to the current method being non-zero to execute the current method. In step S1204, the extension control unit 104 controls a survival status of all the instances generated by the service unit 103 and executes an extension procedure to adjust the number of instances corresponding to each of the methods of the service unit 103 at predetermined intervals.

In some embodiments of the present invention, the extension control unit 104 includes an address-port list. The address-port list includes IP addresses and ports of currently running instances on the service unit 103 of each method. Besides, the address-port list is implemented in the form of string lists, for example, the following address-port list:
method1=[“10.1.10.101:9999”, “10.1.10.102:9999”,
   “10.1.10.105:9999”]
method2=[“10.1.10.103:9999”, “10.1.10.104:9999” ]
method3=[ ]

It indicates that method 1 currently has 3 running instances on the service unit 103, and the IP addresses and ports of the 3 running instances are respectively 10.1.10.101:9999, 10.1.10.102:9999 and 10.1.10.105:9999; method 2 currently has 2 running instances on the service unit 103, and the IP addresses and ports of the 2 running instances are respectively 10.1.10.103:9999 and 10.1.10.104:9999; and method 3 currently has no running instance on the service unit 103.

In some embodiments of the present invention, the address-port list is implemented in the form as recorded in the foregoing embodiment. The selection procedure includes: selecting a first address running instance at a first address from the at least one running instance corresponding to the current method on the address-port list as the service instance. For example, if the current method is method 1, then the first address running instance at the first address among the running instances corresponding to method 1 is the instance with the IP address and port of 10.1.10.101:9999, so the routing unit 102 selects the instance with the IP address and port of 10.1.10.101:9999 as the service instance to execute the current method.

In some embodiments of the present invention, the address-port list is implemented in the form as recorded in the foregoing embodiment. The selection procedure includes: selecting a next address running instance corresponding to the current method after an indicated location on an address-port list in a cyclic manner as the service instance, and pointing the indicated location to the service instance. For example, if the current method is method 1 and the indicated location is 2 (indicating that the indicated address points to the instance with the IP address and port of 10.1.10.102:9999), then the routing unit 102 selects the next location running instance, i.e., the instance with the IP address and port of 10.1.10.105:9999, as the service instance, and points the indicated location to the service instance, i.e., sets the indicated location as 3. The “cyclic manner” means that since the current indicated address is 3, when the routing unit 102 selects the service instance again, the instance after the indicated address is the instance with the IP address and port of 10.1.10.101:9999, i.e., the instance ranking the first.

FIG. 13 is a flowchart of a selection procedure according to some embodiments of the present invention. Referring to FIG. 13, in some embodiments of the present invention, the address-port list is implemented in the form as recorded in the foregoing embodiment. The selection procedure includes step S1301 and step S1302. In step S1301, the routing unit 102 obtains, for all the at least one running instance corresponding to the current method, the running metric of each of the at least one running instance corresponding to the current method according to the metric path of each of the at least one running instance corresponding to the current method recorded in the address-port list. In step S1302, the routing unit 102 selects a smallest running metric instance with the smallest running metric from the at least one running instance corresponding to the current method as the service instance.

For example, the current method is method 1, and the running metric is the CPU load metric, i.e., the CPU load level of the instance. The routing unit 102 obtains, for all the running instances corresponding to method 1 (which are the 3 instances with the IP addresses and ports of 10.1.10.101:9999, 10.1.10.102:9999 and 10.1.10.105:9999 here), the running metric (which is the CPU load metric here) of each of the at least one running instance corresponding to method 1 according to the metric path/metric of each of the at least one running instance corresponding to the current method recorded in the address-port list, i.e., by accessing http://10.1.10.101:9999/metric, http://10.1.10.102:9999/metric and http://10.1.10.105:9999/metric. In step S1302, the routing unit 102 selects a smallest running metric instance with the smallest running metric from the at least one running instance corresponding to the current method as the service instance. For example, if the CPU load metric of the instance with the IP address and port of 10.1.10.101:9999 is 50%, the CPU load metric of the instance with the IP address and port of 10.1.10.102:9999 is 30% and the CPU load metric of the instance with the IP address and port of 10.1.10.105:9999 is 10%, then the smallest running metric is 10%, and the smallest running metric instance is the instance with the IP address and port of 10.1.10.105:9999.

FIG. 14 is a flowchart of an extension procedure according to some embodiments of the present invention. Referring to FIG. 1 and FIG. 14, in the embodiment shown in FIG. 14, the extension control unit 104 executes step S1401 and step S1402 for each of the aforementioned methods according to a sequence (which may be, for example, method 1, method 2, . . . , method M) of the aforementioned method at predetermined intervals (for example, every 1 minute). The method currently in turn is called the current processing method. In step S1401, a first new instance corresponding to the current processing method is added in response to a number of instances corresponding to the current processing method being zero and a number of requests corresponding to the current processing method recorded in the routing unit 102 being non-zero. For example, if the current processing method is method 3, the extension control unit 104 determines, based on the address-port list, whether the number of instances corresponding to the current processing method is zero and the number of requests corresponding to the current processing method recorded in Table (I) in the routing unit 102 is non-zero, and the extension control unit 104 sends the first indication to the service unit 103 to add the first new instance corresponding to the current processing method (method 3 in this example) in response to the number of instances corresponding to the current processing method being zero and the number of requests corresponding to the current processing method recorded in the routing unit 102 being non-zero.

In step S1402, a second new instance corresponding to the current processing method is added in response to the number of instances corresponding to the current processing method being non-zero, and an average running metric of all current processing method instances corresponding to the current processing method being greater than a first metric preset value and a duration being greater than a first predetermined time. For example, the current processing method is method 1, the running metric is the CPU load metric, and the average running metric is the average CPU load metric, i.e., an average of CPU load metrics of all the current processing method instances corresponding to the current processing method. The extension control unit 104 determines whether the number of instances corresponding to the current processing method is non-zero based on the address-port list. If so, the extension control unit 104 obtains, based on the address-port list, each running instance (for example, the aforementioned 3 instances with the IP addresses and ports of 10.1.10.101:9999, 10.1.10.102:9999 and 10.1.10.105:9999) corresponding to the current processing method (method 1 in this example). Each running instance corresponding to the current processing method (method 1 in this example) is also referred to as the current processing method instance. The extension control unit 104 obtains, based on the IP address, port and metric path of each of the current processing method instances, the running metric (CPU load metric in this example) of each of the running instances corresponding to the current method (method 1), such as 20%, 30% and 10%. The extension control unit 104 calculates an average of the obtained running metrics ((20%+30%+10%)/3-20% in this examples) as the average running metric of all the current processing method instances corresponding to the current processing method (method 1). If the average running metric is greater than the first metric preset value (for example, 10%) and the duration is greater than the first predetermined time (for example, 1 minute), the extension control unit 104 sends the first indication to the service unit 103 to add the second instance corresponding to the current processing method (method 1).

It should be noted that the determination sequence of step S1401 and step S1402 may be inverted, and is not limited to the sequence of step S1401 to step S1402 in the present invention.

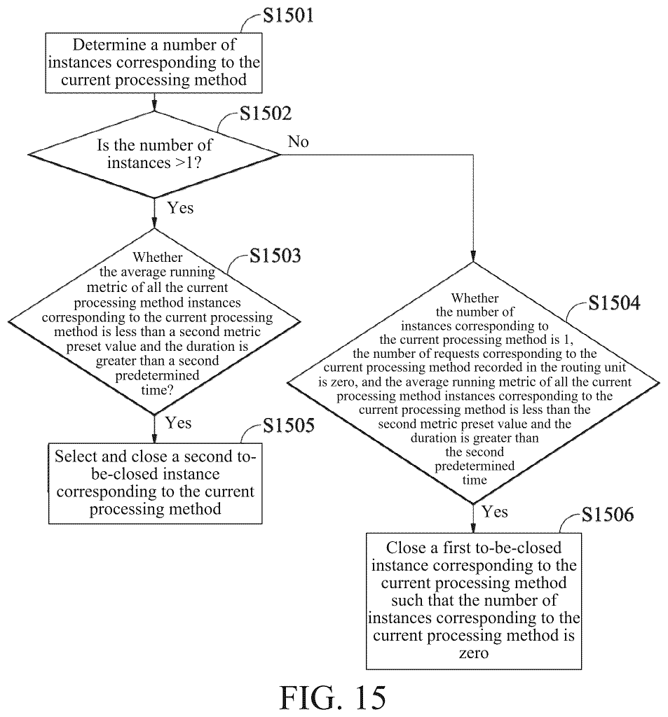

FIG. 15 is a flowchart of an extension procedure according to some embodiments of the present invention. In the embodiment shown in FIG. 14, the extension control unit 104 executes step S1501 to step S1506 for each of the aforementioned methods according to a sequence (which may be, for example, method 1, method 2, . . . , method M) of the aforementioned method at predetermined intervals (for example, every 1 minute). In step S1501, the extension control unit 104 determines the number of instances corresponding to the current processing method. In step S1502, if the extension control unit 104 determines that the number of instances is greater than 1, then step S1503 is executed, otherwise, step S1504 is executed. In step S1503, the extension control unit 104 further determines whether the average running metric of all the current processing method instances corresponding to the current processing method is less than a second metric preset value and the duration is greater than a second predetermined time. If so, step S1505 is executed. In step S1505, the extension control unit 104 selects a to-be-closed instance (which is referred to as a second to-be-closed instance for convenience of description) to be closed from the current processing method instances and sends the second indication to the service unit 103 to close the second to-be-closed instance.

In step S1504, the extension control unit 104 further determines whether the number of instances corresponding to the current processing method is 1, the number of requests corresponding to the current processing method recorded in the routing unit 102 is zero, and the average running metric of all the current processing method instances corresponding to the current processing method is less than the second metric preset value and the duration is greater than the second predetermined time. If so, step S1506 is executed. In step S1506, the extension control unit 104 closes the instance (which is referred to as a first to-be-closed instance for convenience of description) corresponding to the current processing method such that the number of instances corresponding to the current processing method is zero.

For example, the current method is method 1, and the average running metric is the average of the running metrics of all the current processing method instances. The running metric is the CPU load metric, i.e., the CPU load level of the instance. The second metric preset value is set to 10%, and the second predetermined time is set to 1 minute. In step S1501 and step S1502, since the running instances corresponding to method 1 are the 3 instances with the IP addresses and ports of 10.1.10.101:9999, 10.1.10.102:9999 and 10.1.10.105:9999, step S1503 is executed. In step S1503, the extension control unit 104 obtains, for all the running instances (the 3 instances with the IP addresses and ports of 10.1.10.101:9999, 10.1.10.102:9999 and 10.1.10.105:9999 here) corresponding to method 1, the running metric (the CPU load metric here) of each of the at least one running instances corresponding to method 1, such as 9%, 9% and 9%, according to the metric path/metric of each of the at least one running instance corresponding to the current method recorded in the address-port list. The average running metric obtained by the extension control unit 104 is 9%. The extension control unit 104 determines that the average running metric (9%) is less than the second metric preset value (10%) and the duration is greater than the second predetermined time (1 minute), so the extension control unit 104 executes step S1505. In step S1505, the extension control unit 104 selects the second to-be-closed instance (for example, the instance with the IP address and port of 10.1.10.101:9999) from the current processing method instances and sends the second indication to the service unit 103 to close the second to-be-closed instance.

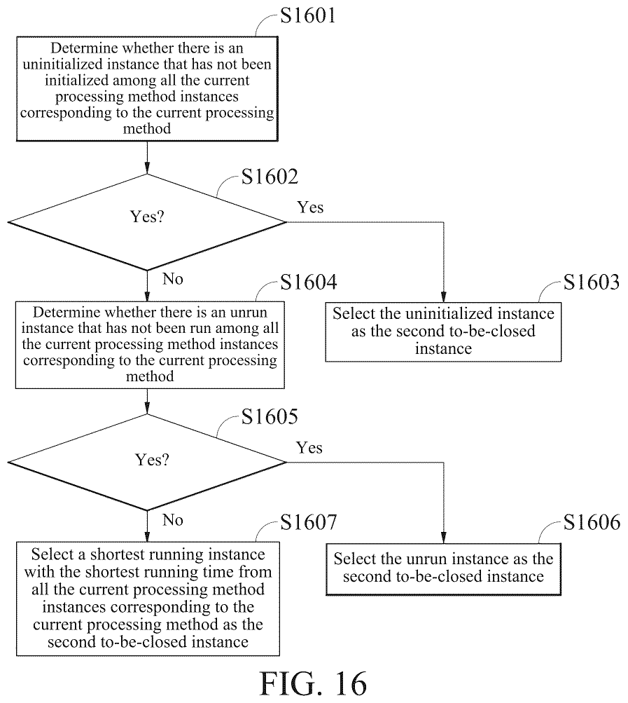

FIG. 16 is a flowchart of an extension procedure according to some embodiments of the present invention. In the embodiment shown in FIG. 16, each of all the current processing method instances corresponding to the current processing method is a container. Step S1505 includes executing step S1601 to step S1607 to select the second to-be-closed instance from the current processing method instances. In step S1601, the extension control unit 104 determines whether there is an uninitialized instance that has not been initialized among all the current processing method instances corresponding to the current processing method. In step S1602, if it is determined that there is an uninitialized instance, then step S1603 is executed, otherwise, step S1604 is executed. In step S1603, the extension control unit 104 selects the uninitialized instance as the second to-be-closed instance. In step S1604, the extension control unit 104 determines whether there is an unrun instance that has not been run among all the current processing method instances corresponding to the current processing method.

In step S1605, if it is determined that there is an unrun instance, then step S1606 is executed, otherwise, step S1607 is executed. In step S1606, the extension control unit 104 selects the unrun instance as the second to-be-closed instance. In step S1607, the extension control unit 104 selects a shortest running instance with the shortest running time from all the current processing method instances corresponding to the current processing method as the second to-be-closed instance.

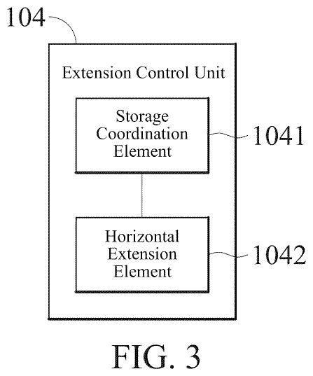

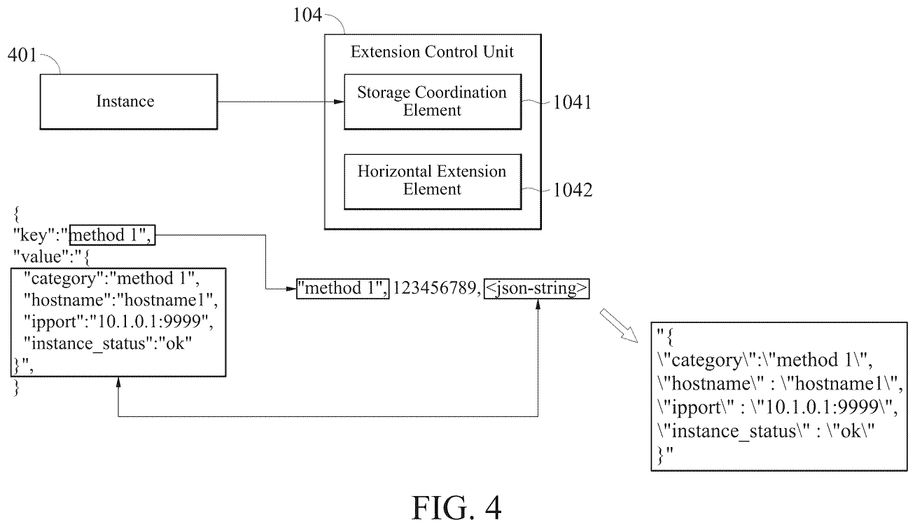

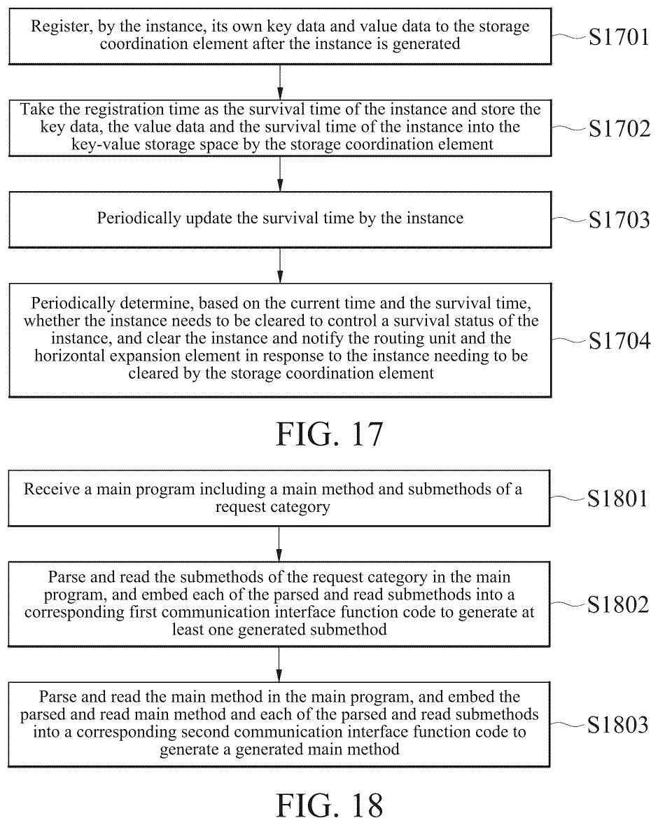

FIG. 3 is a block diagram of an extension control unit according to an embodiment of the present invention. FIG. 4 to FIG. 6 are schematic diagrams showing the operation of the extension control unit according to some embodiments of the present invention. FIG. 17 is a flowchart of a service system execution method according to some embodiments of the present invention. Referring to FIG. 3, FIG. 4 to FIG. 6 and FIG. 17, in some embodiments of the present invention, the extension control unit 104 includes a storage coordination element 1041 and a horizontal extension element 1042. The horizontal extension element 1042 is configured to execute step S1401 to step S1402 illustrated in FIG. 14, step S1501 to step S1506 illustrated in FIG. 15, and step S1601 to step S1607 illustrated in FIG. 16. The storage coordination element 1041 is configured to include a key-value storage space. The service system execution method further includes step S1701 to step S1704 (step S1701 to step S1704 are referred to as a control procedure).

In step S1701, after the instance is generated, the instance registers its own key data and value data to the storage coordination element 1041. In step S1702, the storage coordination element 1041 takes the registration time as the survival time of the instance and stores the key data, the value data and the survival time of the instance into the key-value storage space. In the example shown in FIG. 4, the instance 401 generated has its own key data and value data as follows:

```
{
  “key”: “method 1”,
  “value”: “{
    “category”: “method 1”,
    “hostname”: “hostname1”,
    “ipport”: “10.1.0.1:9999”,
    “instance_status”: “ok”,
  }”,
}
```

The key data has the key “key” and the key “value”. The value corresponding to the key “key” represents which method the instance 401 corresponds to, and in this example, the value corresponding to the key “key” is “method 1”, so the instance 401 corresponds to method 1. The value corresponding to the key “value” is the resource information of the instance 401, and in this example, the resource information of the instance 401 is expressed with json string as:

```
}
  \“category\”: \“method 1\”,
  \“hostname\”: \“hostname1\”,
  \“ipport\”: \“10.1.0.1:9999\”,
  \“instance_status\”: \“ok\”,
}
```

The content of the resource information has been described in detail above, and details will not be repeated here.

Referring to FIG. 4, the key-value storage space includes 3 fields. The first field stores the value (“method 1” in this example) corresponding to the key “key” of the instance. The second field stores the survival time of the instance. Upon the registration of the instance, the storage coordination element 1041 takes the registration time as the survival time of the instance, which is 123456789 in this example. The third field stores the value corresponding to the key “value” of the instance, i.e., the resource information of the instance. In this embodiment, <json-string> shown in FIG. 4 indicates that the value corresponding to the key “value” is stored in the json string format, and may be implemented with the code: json.dumps (values) so as to serialize the entire resource information into data in the json format.

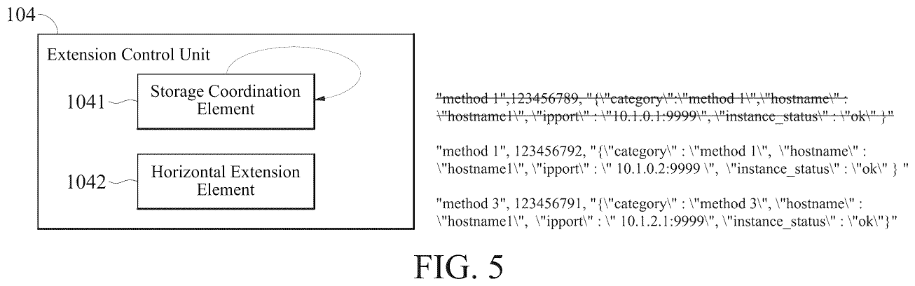

In step S1703, the instance (e.g., the instance 401) periodically updates its own survival time. For example, the instance 401 updates the survival time every 3 seconds, and in this example, the initial survival time is the registration time 123456789, and the survival time will be 123456789+3=123456792 after the next update. In step S1704, the storage coordination element 1041 periodically determines, based on the current time and the survival time, whether the instance needs to be cleared to control a survival status of the instance, and clears the instance in response to the instance needing to be cleared and notifies the routing unit 102 and the horizontal extension element 1042. Referring to FIG. 5, in some embodiments of the present invention, the storage coordination element 1041 compares the current time with the survival time of the instance. If the survival time is less than the current time, then it is determined that the instance needs to the cleared, and the storage coordination element 1041 directly clears the data related to this instance in the key-value storage space to control the survival status of the instance. In the example shown in FIG. 5, the current time is 123456790, so the survival time 123456789 corresponding to the instance ““method 1”, 123456789, “{\” category\”: \“method 1\”,“hostname”: “hostname1\”, “ipport\”: \“10.1.0.1:9999\”, \“instance_status\”: \“ok”}” is less than the current time, and the storage coordination element 1041 determines that this instance needs to be cleared, and thus clears this instance, as shown in FIG. 5. The instances corresponding to ““method 1”, 123456792, “{\” category\”: \ “method 1\”, “hostname”: “hostname1\”, “ipport\”: “10.1.0.2:9999 \”, \ “instance_status”: “ok”} “and “method 3”, 123456791, “{\” category\”: \ “method 3\”, “hostname”: “hostname 1\”, \ “ipport\”: \” 10.1.2.1:9999\ “, “instance_status\”: “ok”}” are retained.

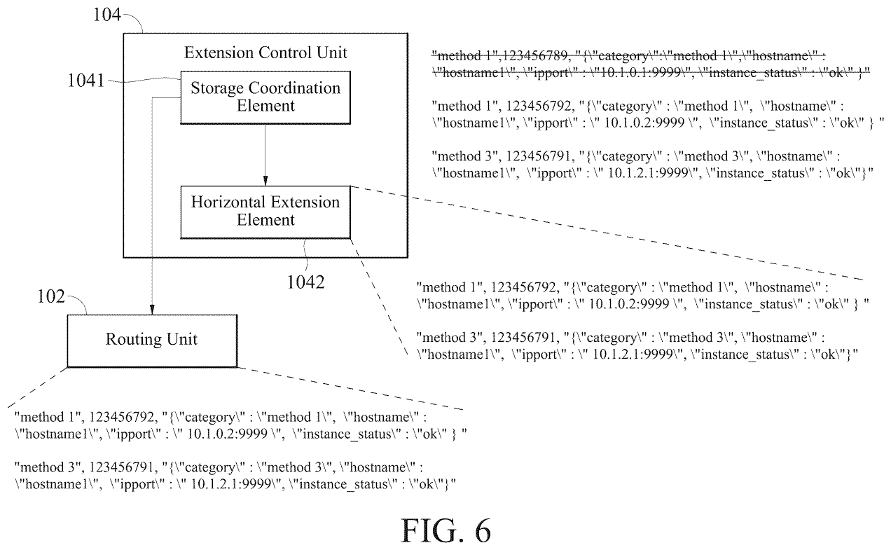

Referring to FIG. 6, in some embodiments of the present invention, the horizontal extension element 1042 and the routing unit 102 stores a copy of the key-value storage space content that is the same as the key-value storage space content of the storage coordination element 1041. When there is a change in the key-value storage space of the storage coordination element 1041, the storage coordination element 1041 notifies the routing unit 102 and the horizontal extension element 1042 to update their respective key-value storage space contents, as shown in FIG. 6.

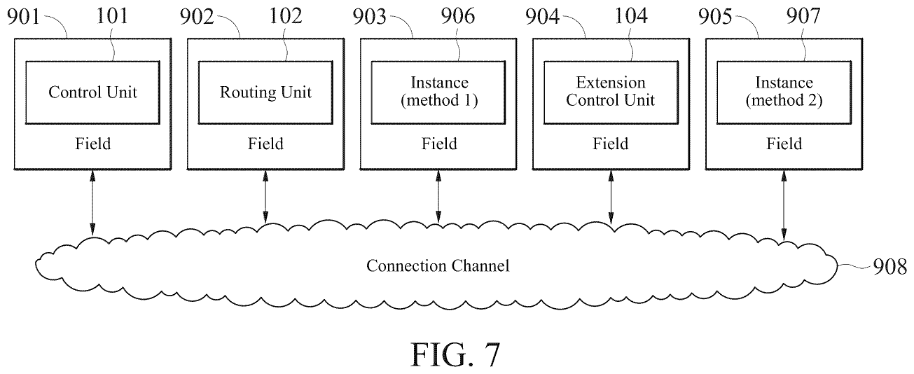

FIG. 7 to FIG. 9 are schematic diagrams showing the implementation of a service system according to some embodiments of the present invention. Referring to FIG. 7, field 901, field 902, field 903, field 904 and field 905 may each a single computer, a single workstation or a micro device in the Internet of Things. In this embodiment, the connection channel 908 is a network, and the network may be comprised of a physical network and a virtual network (if a virtual network is used, it is required to perform Port-mapping on the virtual network and the physical network, and common methods such as ssh tunneling or containerized applications may be realized using dockerhost network). Field 901 to field 905 communicate and transmit data with each other via the connection channel 908 and with HTTP as the interface. In the embodiment shown in FIG. 7, the control unit 101 is implemented in field 901, the routing unit 102 is implemented in field 902, the extension control unit 104 is implemented in field 904, and the control unit 101, the routing unit 102 and the extension control unit 104 may be implemented in each field in software or hardware. The service unit 103 is consists of field 903 and field 905. The instance 906 corresponding to method 1 is a container and is executed in field 903, and the instance 907 corresponding to method 2 is a container and is executed in field 903.

It should be noted that in the embodiment shown in FIG. 7, since the service unit 103 consists of field 903 and field 905, the service system 100 does not need to wake up field 903 and field 905 at the same time at the beginning of the execution, but may wake up the field where the instance needs to be executed by using Wake on Local Area Network (Wake on Lan) technology or Wake on Wide Area Network (Wake on Wan) technology when there is a need to generate instances in the field. For example, the service system 100 wakes up field 903 first at the beginning of the execution and executes the instance 906 in field 903. Then, as needed, instances are added to field 903 (for example, by adding run container in the form of a remote command line: docker run xxxx, or by modifying the number of replicasets in the form of k8s (Kubernetes)). When there is no instance being executed, the field where there is no instance being executed may be closed first. For example, when all the instances in field 905 are closed, field 905 may be closed to save power.

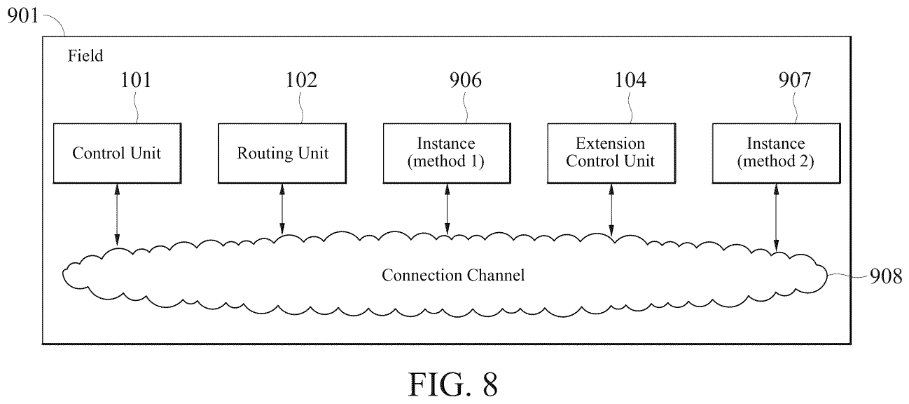

Referring to FIG. 8, in some embodiments of the present invention, the control unit 101, the routing unit 102, the service unit 103 and the extension control unit 104 are all implemented in field 901. The connection channel 908 is a network. The control unit 101, the routing unit 102, the service unit 103 and the extension control unit 104 communicate and transmit data with each other via the connection channel 908 and with HTTP as the interface. The instance generated by the service unit 103 is the container, the instance 906 corresponding to method 1 and the instance 907 corresponding to method 2 are both executed in field 901, and the instance 906 corresponding to method 1, the instance 907 corresponding to method 2, the control unit 101, the routing unit 102, the service unit 103 and the extension control unit 104 communicate and transmit data with each other via the connection channel 908 and with HTTP as the interface.

Referring to FIG. 8, in some embodiments of the present invention, the control unit 101, the routing unit 102, the service unit 103 and the extension control unit 104 are all implemented in field 901, instances generated by the service unit 103 are processes, and the control unit 101 generates instances by Application Programming Interface (API) such as os. CreareProcess or Remote Procedure Call (RPC). The instance 906 corresponding to method 1 and the instance 907 corresponding to method 2 are both executed in field 901. The connection channel 908 is a network or a network socket or a hybrid of a network and a network socket. The control unit 101, the routing unit 102, the service unit 103, the extension control unit 104, the instance 906 corresponding to method 1 and the instance 907 corresponding to method 2 communicate and transmit data with each other via the connection channel 908.

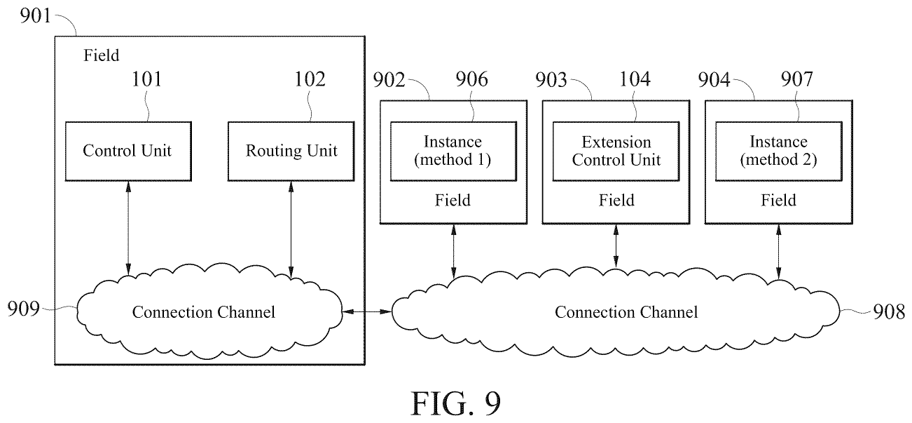

In some embodiments of the present invention, part of the control unit 101, the routing unit 102, the service unit 103 and the extension control unit 104 are implemented in a single field. Referring to FIG. 9, in the example of the embodiment shown in FIG. 9, the control unit 101 and the routing unit 102 are implemented in field 901, the connection channel 909 is a network or a network socket, and the control unit 101 and the routing unit 102 communicate and transmit data with each other via the connection channel 909. The extension control unit 104 is implemented in field 903, and the service unit 103 consists of field 902 and field 904. Field 902 is a micro device, and field 904 is a single computer. The instance 906 corresponding to method 1 is a micro device function program of field 902, and the instance 907 corresponding to method 2 is a container and is executed in field 904. When the extension control unit 104 wants to establish the instance 906, the extension control unit 104 wakes up field 902 by using Wake on Lan technology or Wake on Wan technology and executes the instance 906. The extension control unit 104 generates the instance 907 by adding a run container as described above. The connection channel 908 is a network, and field 902, field 903, field 904, the instance 906 corresponding to method 1, and the instance 907 corresponding to method 2 communicate and transmit data with each other via the connection channel 908. The connection channel 908 and the connection channel 909 are signal-connected with each other such that the control unit 101 and the routing unit 102 can communicate and transmit data with the extension control unit 104, the instance 906 and the instance 907.

The implementations of the service system may be summarized as shown in Table (II) below.

TABLE II

| | | | | |
|---|---|---|---|---|
| Field | Computer Cluster | Single Computer | Single Computer | Internet of |
| | | | | Things Device |
| Communication | Network | Network | Network or network | Network |
| Method | | | socket or hybrid | |
| | | | of network and | |
| | | | network socket | |
| Implementation | Container | Container | Process | Micro device |
| of Instance | | | | |
| Unit That Can | Control unit 101, | Control unit 101, | Control unit 101, | Control unit 101, |
| Implement | service unit 103, | service unit 103, | service unit 103, | service unit 103, |
| | routing unit 102 | routing unit 102 | routing unit 102 | routing unit 102 |
| | and extension | and extension | and extension | and extension |
| | control unit 104 | control unit 104 | control unit 104 | control unit 104 |
| Implementation | Add computers | Add instances | Add instances | Wake on Lan or |
| of Extension | and instances | | | Wake on Wan |
| Procedure | | | | |
| Communication | Http | Http | Http and | Http |
| Interface | | | network socket | |

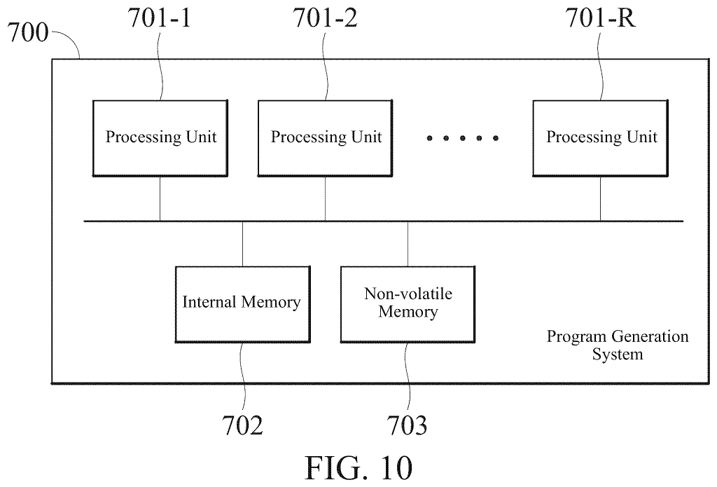

FIG. 10 is a block diagram of a program generation system according to an embodiment of the present invention. Referring to FIG. 10, the program generation system 700 includes processing units 701-1, 701-2 to 701-R (R is a positive integer), an internal memory 702 and a non-volatile memory 703. The internal memory 702 is, for example, a Random-Access Memory (RAM). The non-volatile memory 703 is, for example, at least 1 disk memory, etc. The internal memory 702 and the non-volatile memory 703 are configured to store programs and data. The programs may include codes, and the codes include computer operating instructions. The internal memory 702 and the non-volatile memory 703 provides instructions and data to the processing units 701-1 to 701-R. The processing units 701-1 to 701-R read corresponding computer programs from the non-volatile memory 703 to the internal memory 702 and then run the computer programs.

The program generation method according to some embodiments of the present invention and how modules of the program generation system 700 cooperate with each other will be described in detail below with reference to the accompanying drawings.

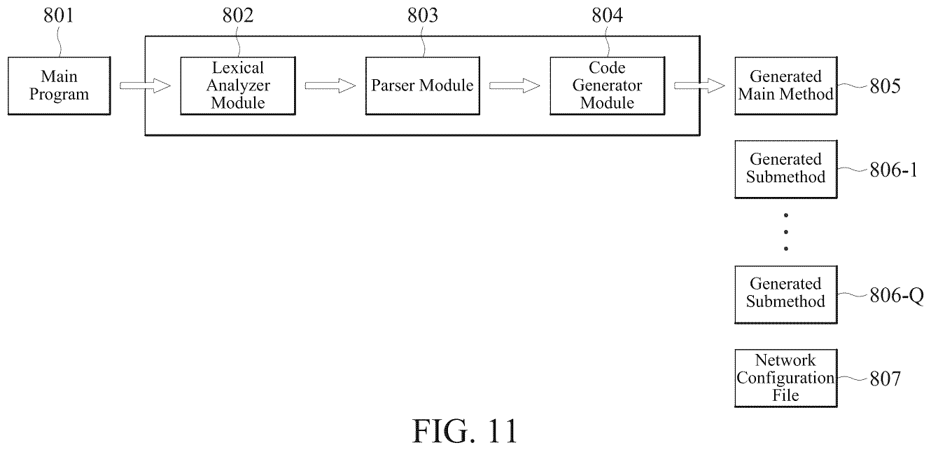

FIG. 11 is a schematic flowchart showing program generation according to an embodiment of the present invention. FIG. 18 is a flowchart of a program generation method according to an embodiment of the present invention. Referring to FIG. 10, FIG. 11 and FIG. 18, in the embodiment shown in FIG. 18, the program generation method includes executing step S1801 to step S1803 by the processing units 701-1, 701-2 to 701-R. In step S1801, a main program 801 is received. The main program includes a main method and at least one submethod of a request category. In some embodiments of the present invention, the request category is public. That is, the submethod of this request category is a public submethod. For example, the main program may be the following main.py code content:

```
def method1(a,b):
  return a+b
def method2(a,b)
    return a-b
def main( ):
    output11=method1(input11, input12)
    output21=method2(input21, output11[0])
return output21
```

The main.py includes the main method main ( ) and submethods method1 (a,b) and method2 (a,b) whose request category are public.

In step S1802, the at least one submethod of the request category in the main program 801 is parsed and read, and each of the parsed and read at least one submethod is embedded into a corresponding first communication interface function code to generate a generated submethod 806-1 to a generated submethod 806-Q. Q is a positive integer. In step S1803, the main method in the main program 801 is parsed and read, and the parsed and read main method and each of the parsed and read at least one submethod are embedded into a corresponding second communication interface function code to generate a generated main method.

In some implementations of the present invention, the first communication interface function code and the second communication interface function code use a network as the communication interface. In this embodiment, after step S1803, the following step is further included: a network configuration file 807 is generated based on the parsed and read main method and the parsed and read at least one submethod of the request category.

In some embodiments of the present invention, the processing units 701-1, 701-2 to 701-R read corresponding computer programs from the non-volatile memory 703 into the internal memory 702 and then run the computer programs to form a lexical analyzer module 802, a parser module 803 and a code generator module 804 on the logical level. The lexical analyzer module 802 performs lexical analysis on the main program 801 to convert a character sequence of the main program 801 into a token sequence. The parser module 803 performs syntactic analysis on outputs of the lexical analyzer module 802 to obtain the parsed and read at least one submethod and the parsed and read main method. The lexical analysis and the syntactic analysis are conventional techniques of the present invention and will not be repeated here.

The following describes an embodiment in which the first communication interface function code and the second communication interface function code use a network as the communication interface. The code generator module 804 embeds each of the parsed and read at least one submethod into the corresponding first communication interface function code to generate a generated submethod 806-1 to a generated submethod 806-Q, and the code generator module 804 embeds the parsed and read main method and each of the parsed and read at least one submethod into the corresponding second communication interface function code to generate a generated main method 805. The code generator module 804 generates a network configuration file 807 based on the parsed and read at least one submethod and the parsed and read main method.

For example, in some embodiments of the present invention, the first communication interface function code has the following mma_template_method1.py code content:

```
### template ####
import json
import psutil
import socket
from http.server import HTTPSever, BaseHTTPRequestHandler
class SimpleHTTPRequestHandler(BaseHTTPRequestHandler):
  ## metric endpoint
  def _{——}init_{——}(self, port=9999):
    self.port = port
  def do_get(self):
    Return {
      ‘hostname ’: socket. gethostname( ),
      “ipport’:‘{ }:{ }’.format(socket.gethostbyname(
      ‘socket.gethostname( )),self.port),
      “category ’:$methodname,
      “cpu_load ’:psutil.cpu_percentage( ),
      “instance_status ’: ‘ok ’,
}
  ##request endpoint
  def do_POST(self):
    content_length=int(self.headers[‘Content-Length’])
    body=self.rfile.read(content_length)
    json_body=json.loads(body)
    ### begin of template ###
    response=$methodname(json_body.params[0],
json_body.params[1],..., json_body.params[$method_paras])
    output = {
        ‘outputs’: [response]
    }
    ### end of template ###
    self.send_response(200)
    self.end_headers( )
    self.wfile.write(json.dumps(outputs))
}
  def serve(self):
    httpd = HTTPSever((‘0.0.0.0’, self.port), self)
    httpd.serve_forever( )
SimpleHTTPRequestHandler( ).serve( )
```

The code generator module 804 embeds the parsed and read submethod method1(a,b) into the first communication interface function code to generate a generated submethod of the submethod method1(a,b) with the following mma_autogen_method1.py code content:

```
### mma_autogen_method1.py #
import json
import psutil
import socket
from http.server import HTTPSever, BaseHTTPRequestHandler
from main import method1
class SimpleHTTPRequestHandler(BaseHTTPRequestHandler):
  ## metric endpoint
  def_{——}init_{——}(self, port-9999):
    self.port = port
  def do_get(self):
    Return {
      ‘hostname’: socket.gethostname( ),
      ‘ipport’:‘{ }:{ }’.format(socket.gethostbyname(
      socket.gethostname( )),self.port),
      ‘category’: ‘method1’,
      ‘cpu_load’: psutil.cpu_percentage( ),
      ‘instance_status': ‘ok’,
    }
##request endpoint
def do_POST(self):
    content_length=int(self.headers[‘Content-Length’])
    body=self.rfile.read(content_length)
    json_body=json.loads(body)
    response=method1(json_body.params[0], json_body.params[1])
    output = {
      ‘outputs':[response]
    }
    self.send_response(200)
    self.end_headers( )
    self.wfile.write(json.dumps(outputs)
}
  def serve(self):
    httpd = HTTPSever((‘0.0.0.0’, self.port), self)
    httpd.serve_forever( )
SimpleHTTPRequestHandler( ).serve( )
```

In some embodiments of the present invention, the second communication interface function code has the following mma_template_main.py code content:

```
  ### template 2 ###
  import requests
  def $methodname($method_params):
    resp = requests.post($routerdomain/proxy, json={“category”: $methodname,
“params”: $method_params})
    return resp.outputs
```

The code generator module 804 embeds the parsed and read main method main ( ) into the second communication interface function code to generate a generated main method of the main method main ( ) with the following mma_autogen_main.py code content:

```
  ### mma_autogen_main.py ###
  import requests
  def method1(a,b):
    resp = requests.post(router-domain/proxy, json={“category”: “method1”,
“params”:[a,b]})
    return resp.outputs[0]
  def method2(a,b):
    resp = requests.post(router-domain/proxy, json={“category”:
“method2”,“params”:[a,b]})
    return resp.outputs[0]
  def main( ):
    output11=method1(input11, input12)
    output21=method2(input21,output11[0])
    return output21
```

In some embodiments of the present invention, the processing units 701-1, 701-2 to 701-R embed the parsed and read main method and the parsed and read at least one submethod of the request category into the following k8s_confiuration_template.yaml network configuration file template code:

```
//http reverse proxy service
apiVersion: v1
kind: Service
metadata:
  name: http-reverse-proxy
spec:
  ports:
    -port: 9999
      name: proxyport
      targetPort: 9999
      protocol: TCP
  selector:
      app: http-reverse-proxy
// http reverse proxy deployment
apiVersion: apps/v1
kind: Deployment
metadata:
  name: http-reverse-proxy
    labels:
      app: http-reverse-proxy
spec:
  selector:
    matchLabels:
      app: http-reverse-proxy
  template:
    metadata:
      labels:
        app: http-reverse-proxy
    containers:
      -name:main
        image:python:3.9
        ports:
          -containerPort:9999
        command:[ “/bin/sh ”]
        args:
          - - c
          ->-
          python http-reverse-proxy.py
// $method deployment
api Version: apps/v1
kind: Deployment
metadata:
  name: $methodname
    labels:
      app:$methodname
spec:
  selector:
    matchLabels:
      app: $methodname
  template:
    metadata:
      labels:
        app: $methodname
    containers:
      -name:main
        image:python:3.9
        ports:
        -containerPort:9999
        command:[ “/bin/sh ”]
        args:
      - -c
      - >-
          python mma_autogen_$methodname.py
```

to generate the network configuration file 807, and generate the following k8s_confiuration.yaml code content of the network configuration file 807:

```
//service http-reverse-proxy
api Version: v1
kind: Service
metadata:
  name: http-reverse-proxy
spec:
  ports:
    -port: 9999
    name: proxyport
    targetPort: 9999
    protocol: TCP
  selector:
    app: http-reverse-proxy
//deployment http-reverse-proxy
api Version: apps/v1
kind: Deployment
metadata:
  name: http-reverse-proxy
    labels:
      app: http-reverse-proxy
spec:
  selector:
    matchLabels:
      app: http-reverse-proxy
  template:
    metadata:
      labels:
        app: http-reverse-proxy
  containers:
    -name:main
      image:python:3.9
      ports:
        -containerPort:9999
      command:[ “/bin/sh”]
      args:
        - -c
        - >-
          python http-reverse-proxy.py
//service method1
api Version: v1
kind: Service
metadata:
  name: method1
spec:
  ports:
    -port: 9999
      name: methodport
      targetPort: 9999
      protocol: TCP
  selector:
      app: method1
//service method2
apiVersion: v1
kind: Service
metadata:
  name: method2
spec:
  ports:
    -port: 9999
      name: methodport
      targetPort: 9999
      protocol: TCP
  selector:
      app: method2
//deployment method1.py
api Version: apps/v1
kind: Deployment
metadata:
  name: method1
    labels:
      app: method1
spec:
  selector:
    matchLabels:
      app: method1
  template:
    metadata:
      labels:
        app: method1
    containers:
        -name:main
        image:python:3.9
        ports:
          -containerPort:9999
        command:[ “/bin/sh”]
        args:
          - -c
          - >-
            python mma_autogen_method1.py
//deployment method2.py
apiVersion: apps/v1
kind: Deployment
metadata:
  name: method2
    labels:
      app: method2
spec:
  selector:
    matchLabels:
      app: method2
  template:
    metadata:
      labels:
        app: method2
    containers:
      -name:main
        image:python:3.9
        ports:
          -containerPort:9999
        command:[ “/bin/sh”]
        args:
          - - c
          - >-
              python mma_autogen_method2.py
```

In some embodiments of the present invention, the service system 100 cooperates with the program generation system 700. The service system 100 receives outputs of the program generation system 700, method 1, method 2 to method M are generated by the program generation system 700 executing steps S1801 to S1803, and the control unit 101 executes the generated main method.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A program generation system, comprising at least one processing unit, the at least one processing unit being configured to receive a main program comprising a main method and at least one submethod of a request category, and execute the following steps:
(a) parsing and reading the at least one submethod of the request category in the main program, and embedding each of the parsed and read at least one submethod into a corresponding first communication interface function code to generate at least one generated submethod; and
(b) parsing and reading the main method in the main program, and embedding the parsed and read main method and each of the parsed and read at least one submethod into a corresponding second communication interface function code to generate a generated main method.

2. The program generation system according to claim 1, wherein the at least one processing unit is configured to execute: (c) generating a network configuration file based on the parsed and read main method and the parsed and read at least one submethod of the request category.

3. A service system cooperating with the program generation system according to claim 1, comprising:
a control unit, configured to receive an external request and call a plurality of methods sequentially based on the external request;
a service unit, configured to generate and run an instance based on a first indication and close the instance based on a second indication, the instance corresponding to one of the methods;
a routing unit, configured to receive a call parameter of a current method called from the methods and execute: recording a request of the current method and the call parameter of the current method in response to a number of instances corresponding to the current method being zero; and selecting a service instance from at least one running instance corresponding to the current method based on a selection procedure in response to the number of instances corresponding to the current method being non-zero; and
an extension control unit, configured to control a survival status of all the instances generated by the service unit and execute an extension procedure to adjust the number of instances corresponding to each of the methods of the service unit at predetermined intervals, wherein the control unit executes the generated main method, and the methods are the at least one generated submethod.

4. A service system, comprising:
a control unit, configured to receive an external request and call a plurality of methods sequentially based on the external request;
a service unit, configured to generate and run an instance based on a first indication and close the instance based on a second indication, the instance corresponding to one of the methods;
a routing unit, configured to receive a call parameter of a current method called from the methods and execute: recording a request of the current method and the call parameter of the current method in response to a number of instances corresponding to the current method being zero; and selecting a service instance from at least one running instance corresponding to the current method based on a selection procedure in response to the number of instances corresponding to the current method being non-zero; and
an extension control unit, configured to control a survival status of all the instances generated by the service unit and execute an extension procedure to adjust the number of instances corresponding to each of the methods of the service unit at predetermined intervals.

5. The service system according to claim 4, wherein the selection procedure comprises: selecting a first address running instance at a first address from the at least one running instance corresponding to the current method on an address-port list as the service instance.

6. The service system according to claim 4, wherein the selection procedure comprises: selecting a next address running instance corresponding to the current method after an indication address on an address-port list in a cyclic manner as the service instance.

7. The service system according to claim 4, wherein the selection procedure comprises: obtaining, for all the at least one running instance corresponding to the current method, the running metric of each of the at least one running instance corresponding to the current method according to a metric path of each of the at least one running instance corresponding to the current method recorded in the address-port list and selecting a smallest running metric instance with the smallest running metric from the at least one running instance corresponding to the current method as the service instance.

8. The service system according to claim 4, wherein the extension procedure comprises:
executing the following steps for a current processing method among the methods:
(a) adding, in response to a number of instances corresponding to the current processing method being zero and a number of requests corresponding to the current processing method recorded in the routing unit being non-zero, a first new instance corresponding to the current processing method; and
(b) adding, in response to the number of instances corresponding to the current processing method being non-zero, and an average running metric of all current processing method instances corresponding to the current processing method being greater than a first metric preset value and a duration being greater than a first predetermined time, a second new instance corresponding to the current processing method.

9. The service system according to claim 4, wherein the extension procedure comprises:
executing the following steps for a current processing method among the methods:
(a) closing, in response to a number of instances corresponding to the current processing method being 1, a number of requests corresponding to the current processing method recorded in the routing unit being zero, and an average running metric of all current processing method instances corresponding to the current processing method being less than a second metric preset value and a duration being greater than a second predetermined time, a first to-be-closed instance corresponding to the current processing method such that the number of instances corresponding to the current processing method is zero; and
(b) selecting and closing, in response to the number of instances corresponding to the current processing method being greater than 1, and the average running metric of all current processing method instances corresponding to the current processing method being less than the second metric preset value and the duration being greater than the second predetermined time, a second to-be-closed instance corresponding to the current processing method.

10. The service system according to claim 4, wherein the extension control unit comprises a storage coordination element and a horizontal extension element, the horizontal extension element is configured to execute the extension procedure, the storage coordination element comprises a key-value storage space, and the service system is configured to execute a control procedure comprising:
(a) registering a key data and a value data of the instance to the storage coordination element by using the instance after the instance is generated;
(b) taking a registration time as a survival time of the instance and storing the key data, the value data, and the survival time of the instance into the key-value storage space by using the storage coordination element;
(c) periodically updating the survival time by the instance; and
(d) periodically determining whether the instance needs to be cleared to control a survival status of the instance based on a current time and the survival time by using the storage coordination element and, in response to the instance needing to be cleared, clearing the instance and notifying the routing unit and the horizontal extension element by using the storage coordination element.

11. A program generation method, executed by at least one processing unit, comprising the following steps:
(a) receiving a main program comprising a main method and at least one submethod of a request category;
(b) parsing and reading the at least one submethod of the request category in the main program, and embedding each of the parsed and read at least one submethod into a corresponding first communication interface function code to generate at least one generated submethod; and
(c) parsing and reading the main method in the main program, and embedding the parsed and read main method and each of the parsed and read at least one submethod into a corresponding second communication interface function code to generate a generated main method.

12. The program generation method according to claim 11, comprising:
(d) generating a network configuration file based on the parsed and read main method and the parsed and read at least one submethod of the request category.

13. A computer-readable recording medium storing a program, wherein when a processing unit loads the program and executes the program, the method according to claim 11 is performed.

14. A non-transitory computer program product storing at least one instruction, when the at least one instruction is executed by a processing unit, the processing unit performs the method according to claim 11.

15. A service system execution method cooperating with the program generation method according to claim 7, applicable to a service system comprising a control unit, a service unit, a routing unit and an extension control unit, the service system execution method comprising the following steps:
(a) receiving an external request and calling a plurality of methods sequentially based on the external request by the control unit;
(b) generating and running an instance based on a first indication and closing the instance based on a second indication, the instance corresponding to one of the methods by the service unit;
(c) receiving a call parameter of a current method called from the methods and executing: recording a request of the current method and the call parameter of the current method in response to a number of instances corresponding to the current method being zero; and selecting a service instance from at least one running instance corresponding to the current method based on a selection procedure in response to the number of instances corresponding to the current method being non-zero by the routing unit; and
(d) controlling a survival status of all the instances generated by the service unit and executing an extension procedure to adjust the number of instances corresponding to each of the methods of the service unit at predetermined intervals, wherein the control unit executes the generated main method, and the methods are the at least one generated submethod by the extension control unit.

16. A service system execution method, applicable to a service system comprising a control unit, a service unit, a routing unit and an extension control unit, the service system execution method comprising the following steps:
(a) receiving an external request and calling a plurality of methods sequentially based on the external request by the control unit;
(b) generating and running an instance based on a first indication and closing the instance based on a second indication by the service unit, the instance corresponding to one of the methods;
(c) receiving a call parameter of a current method called from the methods and executing: recording a request of the current method and the call parameter of the current method in response to a number of instances corresponding to the current method being zero; and selecting a service instance from at least one running instance corresponding to the current method based on a selection procedure in response to the number of instances corresponding to the current method being non-zero by the routing unit; and
(d) controlling a survival status of all the instances generated by the service unit and executing an extension procedure to adjust the number of instances corresponding to each of the methods of the service unit at predetermined intervals by the extension control unit.

17. The service system execution method according to claim 16, wherein the selection procedure comprises following steps:
(c1) obtaining, for all the at least one running instance corresponding to the current method, a running metric of each of the at least one running instance corresponding to the current method according to a metric path of each of the at least one running instance corresponding to the current method recorded in the address-port list; and
(c2) selecting a smallest running metric instance with a smallest running metric from the at least one running instance corresponding to the current method as the service instance.

18. The service system according to claim 16, wherein the extension procedure comprises:
executing the following steps for a current processing method among the methods:
(d1) adding, in response to a number of instances corresponding to the current processing method being zero and a number of requests corresponding to the current processing method recorded in the routing unit being non-zero, a first new instance corresponding to the current processing method; and
(d2) adding, in response to the number of instances corresponding to the current processing method being non-zero, and an average running metric of all current processing method instances corresponding to the current processing method being greater than a first metric preset value and a duration being greater than a first predetermined time, a second new instance corresponding to the current processing method.

19. The service system according to claim 16, wherein the extension procedure comprises:
executing the following steps for a current processing method among the methods:
(d1) closing, in response to a number of instances corresponding to the current processing method being 1, a number of requests corresponding to the current processing method recorded in the routing unit being zero, and an average running metric of all current processing method instances corresponding to the current processing method being less than a second metric preset value and a duration being greater than a second predetermined time, a first to-be-closed instance corresponding to the current processing method such that the number of instances corresponding to the current processing method is zero; and
(d2) selecting and closing, in response to the number of instances corresponding to the current processing method being greater than 1, and the average running metric of all current processing method instances corresponding to the current processing method being less than the second metric preset value and the duration being greater than the second predetermined time, a second to-be-closed instance corresponding to the current processing method.

20. The service system execution method according to claim 16, wherein the extension control unit comprises a storage coordination element and a horizontal extension element, the horizontal extension element is configured to execute the extension procedure, the storage coordination element comprises a key-value storage space, and the service system is configured to execute a control procedure comprising:
(d1) registering a key data and a value data of the instance to the storage coordination element by the instance after the instance is generated;
(d2) taking a registration time as a survival time of the instance and storing the key data, the value data, and the survival time of the instance into the key-value storage space by the storage coordination element;
(d3) periodically updating the survival time by the instance; and
(d4) periodically determining whether the instance needs to be cleared to control a survival status of the instance based on a current time and the survival time and, in response to the instance needing to be cleared, clearing the instance and notifying the routing unit and the horizontal extension element by using the storage coordination element by the storage coordination element.
